(19) United States
(12) Patent Application Publication
(10) Pub. No.: US 2002/0090072 A1
(43) Pub. Date: Jul. 11, 2002

(54) Method and system for providing a remote call accounting system

(75) Inventor: Brent Rumsey, Dallas, TX (US)

Correspondence Address: Sanford E. Warren, Jr., GARDERE WYNNE SEWELL LLP, Suite 3000, 1601 Elm Street, Dallas, TX, 75201, US

(73) Assignee: TIV, LLC

(21) Appl. No.: 09/757,754

(22) Filed: Jan. 9, 2001

(51) Int. Cl. H04M 15/00

(52) U.S. Cl. 379/118; 379/112.01; 379/120; 379/140

(57) ABSTRACT

The present invention provides a method and system for remotely processing a data string. The method includes the steps of generating a data string from a communications device, which may be a telephone or a modem, and attaching an identifier code to the data string. The data string is then transmitted to a remote processor that reads the identifier code and processes the data string according to an algorithm designated by the identifier code.

### FIELD OF THE INVENTION

The present invention relates generally to the field of telecommunication systems, and more particularly, to a method and system for providing a remote call accounting system to hotels.

### BACKGROUND OF THE INVENTION

Without limiting the scope of the invention, this background of the present invention will be described with reference to providing a remote call accounting system to a hotel, as an example. Hotels may generate significant revenue by accounting for guests' telephone use and then billing guests for their use. Hotels often implement unique algorithms to determine a correct charge for a particular use. Many factors such as time of day, length of call, or destination of call, for example, may be considered to develop an appropriate bill. However, recording and processing these factors requires considerable equipment and personnel costs.

Typically, a hotel invests in three components to account for telephone system use and bill guests for their use. First, the hotel's telephone system has a telephone switch, or Public Branch Exchange (PBX), that routes a call from a handset in the hotel to a local telecom provider system. The PBX creates a call record that may be up to 150 bytes long, which represents information related to the call, such as origin, destination, connection status and duration. Next, a Call Accounting System (CAS) processes the call information from the PBX and assigns a rate to the individual calls. Finally, a Property Management System (PMS) integrates information from the CAS into the guest bill. The PMS may generate a bill that includes detailed information related to the guest's telephone use.

The problem with such a system is that the CAS is expensive to purchase maintain and operate. Specifically, the initial purchase price of the CAS may range from five thousand to twenty thousand dollars depending on the number of features. In addition, the CAS inevitably becomes outdated or obsolete within a few years. Consequently, the hotel must either continue to use inferior and possibly inadequate equipment or incur additional significant capital expenditure to upgrade or replace the CAS.

Moreover, hotels incur additional costs because they must train employees to operate and maintain the CAS. Unfortunately, the hotel service industry has high 10 attrition. Therefore, the cost of training an employee to operate and maintain the CAS may never be recovered or, even worse, the training cost may be lost to a competitor if the trained employee quits to work for the competitor. All of these scenarios are costly and frustrating to hotel managers and are ultimately passed on to guests through higher costs.

Accordingly, there is a need for a system and method for providing a Call Accounting System that overcomes the present costs and inefficiencies of purchasing and maintaining a CAS.

### SUMMARY OF THE INVENTION

The present invention provides a method and system for remotely processing a data string. The method includes the steps of generating a data string from a communications device, which may be a telephone or a modem, and attaching an identifier code to the data string. The data string is then transmitted to a remote processor that reads the identifier code and processes the data string according to an algorithm designated by the identifier code.

The present invention also provides a method for remotely generating a hotel guest bill. The method includes the steps of generating a data string from a communications device in the hotel and attaching an identifier code to the data string. The identifier code is unique to the hotel. The data string is then transmitted to a Remote Call Accounting System (RCAS) outside of the hotel. The identifier code read and the data string is processed according to an algorithm, which is determined by the identifier code. A result is returned from processing the data string and the result has a value. The value is then transmitted to a Remote Property Management System (RPMS) and included in the hotel guest bill.

The present invention further provides a method for processing a data string. The method includes the steps of receiving the data string from a remote location. A communications device generates the data string, which has an attached identifier code. The identifier code is read to identify a source of the data string and then the data string is processed according to an algorithm designated by the identifier code.

In addition, the present invention provides a system for remotely processing call information. The system has a device to generate a data string from a communications device and a device to assign an identifier code to the data string. A data string processor uses an algorithm to process the data string. The algorithm is selected according to the identifier code.

The present invention also provides a computer program embodied on a computer readable medium for remotely processing information. The computer program has a code segment for reading a data string having an identifier code. Another code segment retrieves an algorithm according to the identifier code. The computer program also has a code segment to process the data string using the algorithm and to generate processed data.

Other features and advantages of the present invention shall be apparent to those of ordinary skill in the art upon reference to the following detailed description taken in conjunction with the accompanying drawings.

### BRIEF DESCRIPTION OF THE DRAWINGS

The above and further advantages of the invention may be better understood by referring to the following description in conjunction with the accompanying drawings in which corresponding numerals in the different figures refer to corresponding parts and in which:

FIG. 1 is a relational diagram of a prior art hotel telephone network;

FIG. 2 is a relational diagram of a hotel telephone network in accordance with certain embodiments of the present invention;

FIG. 3 is a relational diagram of a remote call accounting system in accordance with certain embodiments of the present invention; and

FIG. 4 is a relational diagram of a remote call accounting system in accordance with certain embodiments of the present invention.

### DETAILED DESCRIPTION

Although making and using various embodiments of the present invention are discussed herein in terms of providing a remote Call Accounting System (CAS), it should be appreciated that the present invention provides many applicable inventive concepts that can be embodied in a wide variety of specific contexts. The specific embodiments discussed herein are merely illustrative of specific ways to make and use the invention and do not limit the scope of the invention.

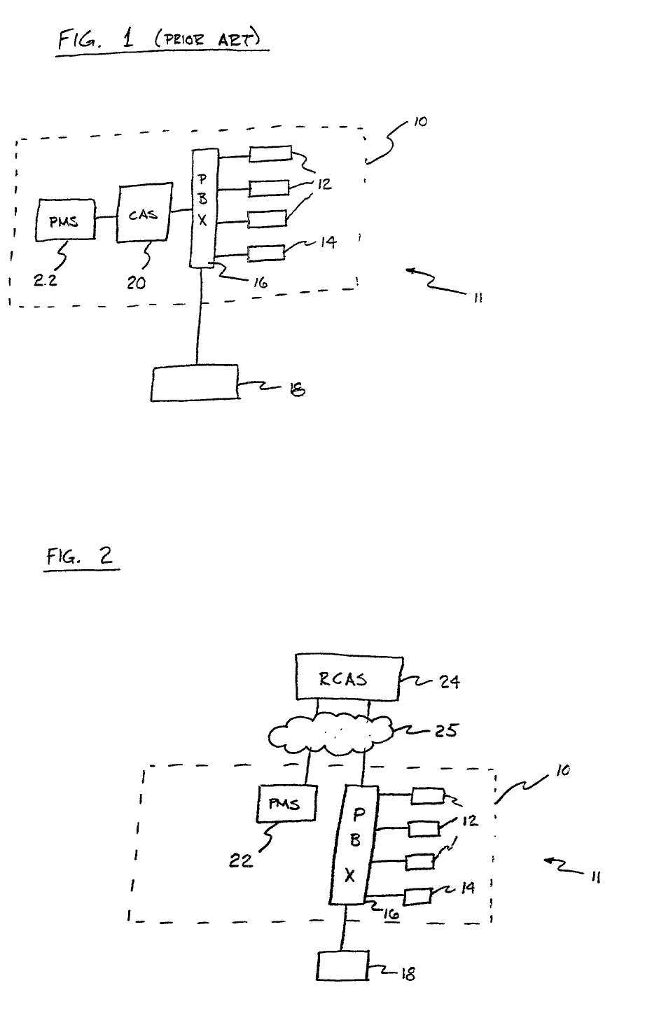

FIG. 1 depicts a hotel 10 that has a telephone network 11 according to the prior art. The telephone network 11 may have many different components such as guest handsets 12, administrative handsets 14, a telephone switch, or Public Branch Exchange (PBX) 16, a Call Accounting System (CAS) 20 and a Property Management System (PMS) 22. The hotel 10 has a connection to a local telephone network 18, which allows handsets 12, 14 within the hotel 10 to connect to phone lines outside of the hotel 10.

A typical call accounting process in the prior art telephone network 11 begins when a guest places a call with the guest handset 12. The call is routed through the PBX 16, which directs the call to the proper destination. The PBX 16 also assigns a data string to the call. The data string may be up to 150 bytes in length and contain information related to the call such as time of call origin, call destination, connection success, and total length of the call. The data string is then routed to the CAS 20, which is located on the hotel premises. The CAS 20 reads the call string and assigns a value, which may be the cost of the call, to the call based on a pre-programmed algorithm in the CAS 20. The CAS 20 is a computer server that is located on the hotel property. Desired call information and the value may then be sent from the CAS 20 to the PMS 22. The PMS 22 compiles a guest bill that includes various charges from the hotel such as meals from a restaurant or room service, gift shop purchases, and telephone use.

Now turning to a description of the present invention, FIG. 2 depicts a Remote Call Accounting System (RCAS) 24 that is integrated into the telephone network 11. A call from the handsets 12, 14 is routed through the PBX 16, which generates a data string that contains information related to the call. The data string may then be sent to the RCAS 24 through a communications network 25 such as the Internet, for example. This allows the RCAS 24 to be removed from the hotel 10, which reduces costs related to housing and operating the CAS 20 on the premises of the hotel 10. Costs are also saved because several hotels 10 can share the RCAS 20.

The PBX 16 may attach an identifier code to the data string that identifies the source of the data string. The identifier code may identify a unique characteristic of the source such as the hotel name, the hotel city, or the hotel's operating company, for example. The RCAS 24 receives the data string from the PBX 16 and can process the information contained in the data string according to an algorithm associated with the particular source.

For example, the source may be a foreign property of a chain of domestic hotels. The RCAS 24 may be located in the United States and the PBX 16 may be located at the foreign property. If a guest at the foreign property places a call with the guest handset 12, the PBX 16 generates a data string that contains information related to the call. The call information may be transmitted over the communications network 25, which may be the Internet, through phone lines, or by satellite, to the RCAS 24. When the RCAS 24 receives the data string, it recognizes the identifier code and determines that the data string is from the foreign property. The RCAS 24 then processes the data string according to an algorithm that may be unique to the foreign property.

Unique algorithms may be individually tailored to generate customized call billing. For example, the RCAS 24 may be programmed to charge different rates for daytime calls and evening calls. Long distance and local calls may also incur different rates. Alternatively, some properties may not charge guests for local calls. The identifier code attached to the data string may uniquely instruct the RCAS 24 how to process the data string according to revenue models developed by the hotel 10 or special arrangements for individual guests.

After the RCAS 24 processes the data string and determines the rate for the call, the processed data may be sent back to the PMS 22 in the hotel. The PMS 22 then incorporates call information and call cost into the guest's room bill. Alternatively, the processed data may be stored in the RCAS 24 and accessed from the hotel 10 through the communications network 25. Remote access to the processed data will be described in more detail below.

Turning now to FIG. 3, the RCAS 24 may be divided into multiple partitions 26a-d to accommodate data strings from multiple hotels 10a-d. Each partition may house different algorithms to process the data strings according to the rate structures of the different hotels 10a-d. Consequently, the hotels 10a-d may be different hotel properties within a single management group or the hotels 10a-d may be independent of each other. The hotels 10a-d may be located within the same town or they may even be on different continents. The identifier code attached to the data string may identify the source of the data string and allow the RCAS 24 to route the data string to the appropriate partition 26a-d for processing.

Because a single RCAS 24 may be utilized by multiple hotels 10a-d, the hotels 10a-d may provide valuable features associated with the most advanced RCAS 24 at a fraction of the cost required to purchase the most advanced RCAS 24. Although smaller or under-funded hotels 10a-d may not want to purchase the most advanced RCAS 24, they may provide guests with the features of the most advanced RCAS 24 by sharing the RCAS 24 with multiple hotels 10a-d. The hotels 10a-d also realize additional benefits from the RCAS 24 because the hotels 10a-d may not need to invest in training their employees to use and maintain the RCAS 24. Additionally, the hotels 10a-d may not need to update the RCAS 24 when the RCAS 24 becomes outdated or obsolete. The hotels 10a-d also save costs because the RCAS 24 may be operated, modified, maintained and upgraded from a single location and the hotels 10a-d may simply pay for the RCAS 24 service, which may be provided by a third party service provider.

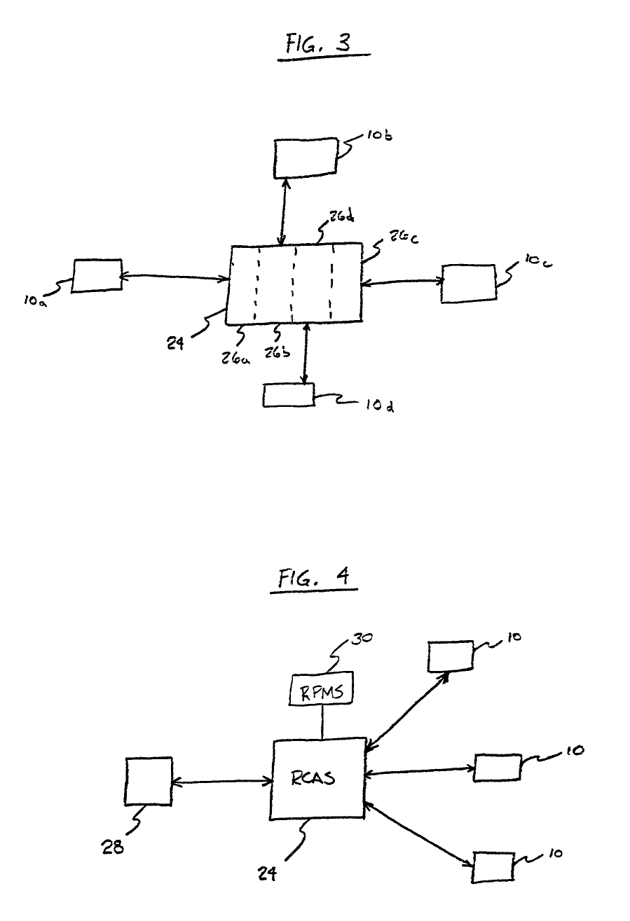

FIG. 4 depicts an access terminal 28 that may be utilized by multiple hotels 10 to access the RCAS 24. The access terminal 28 may be a computer terminal that may interface with the RCAS 24 through the communications network 25, such as the Internet, for example, or through a dedicated network, satellite transmission or wireless communications link. Therefore, a remotely located corporate office of the hotels 10 may access information on the RCAS 24. The corporate office may review and analyze data sent to the RCAS 24 by the hotels 10 to evaluate the effectiveness of a particular algorithm for an individual hotel 10. The access terminal 28 may also be used to compare the hotels 10 and identify potential problems or improve efficiency in guest services.

For example, the corporate office or a regional manager may use the access terminal 28 to determine that a particular hotel 10 in a region has significantly greater costs for administrative phone calls than other hotels 10 in the region. Individual hotels 10 may also access their own call records to determine how call revenue fluctuates during different times of the day or days of the week. This information may be used to alter call rate structures to increase use and revenue. The access terminal 28 may also be used to alter call rates for an individual extension in the hotel 10, a block of rooms in the hotel 10, or several hotels 10 in a particular region.

To increase security and confidentiality, the RCAS 24 may have a password-protection system that allows different levels of access to data stored on the RCAS 24. The corporate office of a group of hotels 10 may have access to data from all of the hotels 10, but the manager of an individual hotel 10 may only be granted access to data from the manager's hotel 10. A regional manager may have access to data from all of the hotels 10 in the region. Naturally, if data from several competing hotels 10 is stored on the same RCAS 24, the data from one hotel 10 may be protected from access by a competitor.

The RCAS 24 may also receive data from the hotels 10 and transmit the data to a Remote Property Management System (RPMS) 30. The RPMS 30 may receive call information from the RCAS 24 and combine it with other guest information from the hotels 10 to generate the guest bill. The hotels 10 may send information related to guest room charges to the RCAS 24, which distributes the information to the RPMS 30 for compilation. The hotels 10 may access the RPMS 30 to retrieve individual room bills, which may be reviewed and modified or presented to the guest upon departure from the hotel 10. In this example, each hotel 10 may have an access terminal 28. Similar to the RCAS 26, a significant advantage to the RPMS 30 is that a separate PMS 22 is not required for each hotel 10. Therefore, the cost of the RPMS 30 may be distributed among several hotels 10 or a third party may provide the RPMS 30 and charge hotels 10 to access service from the RPMS 30.

While specific alternatives to steps of the invention have been described herein, additional alternatives not specifically disclosed but known in the art are intended to fall within the scope of the invention. Thus, it is understood that other applications of the present invention will be apparent to those skilled in the art upon the reading of the described embodiment and a consideration of the appended claims and drawings.

What is claimed is:

1. A method for remotely processing a data string comprising the steps of:
receiving a data string from a communications device;
attaching an identifier code to the data string;
transmitting the data string to a remote processor;
reading the identifier code to identify a source of the data string; and
processing the data string according to an algorithm designated by the identifier code.

2. The method as recited in claim 1 wherein the data string originates from a telephone.

3. The method as recited in claim 1 wherein the data string originates from a modem.

4. The method as recited in claim 1 wherein the communications device is a PBX.

5. The method as recited in claim 1 wherein the source is a hotel.

6. The method as recited in claim 1 further comprising the step of returning processed data to the source.

7. The method as recited in claim 6 further comprises the step of accessing the processed data from a remote location.

8. The method as recited in claim 1 further comprising the steps of storing processed data in a partition and accessing the data from the source.

9. The method as recited in claim 1 wherein a first data string from a first source is processed by a first algorithm and a second data string from a second source is processed by a second algorithm.

10. The method as recited in claim 1 wherein the communications device is a telephone in a hotel and the data string is transmitted over a communications network to the remote processor.

11. The method as recited in claim 10 wherein processed data from the remote processor is transmitted over the communications network.

12. A method for remotely generating a hotel guest bill comprising:
receiving a data string from a communications device in the hotel;
attaching an identifier code to the data string, the identifier code unique to the hotel;
transmitting the data string to a Remote Call Accounting System (RCAS) outside of the hotel;
reading the identifier code and processing the data string according to an algorithm, the algorithm determined by the identifier code;
returning a result from processing the data string, the result having a value;
transmitting the value to a Remote Property Management System (RPMS); and
including the value in the hotel guest bill.

13. The method as recited in claim 12 wherein the communications device is a telephone.

14. The method as recited in claim 12 wherein the communications device is a modem.

15. The method as recited in claim 12 wherein the RCAS receives a first data string from a first hotel and a second data string from a second hotel.

16. The method as recited in claim 12 wherein the data string is transmitted through a communications network.

17. The method as recited in claim 16 further comprising the step accessing the hotel guest bill through the communications network.

18. A method for processing a data string comprising the steps of:
receiving a data string from a remote location, the data string generated by a
communications device and having an identifier code attached to the data string;
reading the identifier code to identify a source of the data string; and
processing the data string according to an algorithm designated by the identifier code.

19. The method as recited in claim 18 wherein the communications device is a telephone.

20. The method as recited in claim 18 wherein the communications device is a modem.

21. The method as recited in claim 18 wherein the data string is generated by a PBX.

22. The method as recited in claim 18 wherein the source is a hotel.

23. The method as recited in claim 18 further comprising the step of returning processed data to the source.

24. The method as recited in claim 23 further comprises the step of accessing the processed data from a remote location.

25. The method as recited in claim 18 further comprising the steps of storing processed data in a partition and providing access to the data.

26. The method as recited in claim 18 wherein a first data string from a first source is processed by a first algorithm and a second data string from a second source is processed by a second algorithm.

27. A system for remotely processing call information comprising:
a device to generate a data string from a communications device;
a device to assign an identifier code to the data string; and
a processor having two or more algorithms wherein the data string is processed by one of the algorithms based on the identifier code.

28. The system as recited in claim 27 further comprising an access terminal to retrieve processed data from the processor.

29. The system as recited in claim 27 wherein the communications device is a telephone.

30. The system as recited in claim 27 wherein the communications device is a modem.

31. The system as recited in claim 27 wherein the communications device is a telephone and the data string is transmitted over a communications network to the processor.

32. The system as recited in claim 31 wherein processed data from the data string processor is transmitted over the communications network.

33. A computer program embodied on a computer readable medium for remotely processing information comprising:
a code segment for reading a data string, the data string having an identifier code;
a code segment for retrieving an algorithm according to the identifier code; and
a code segment for processing the data string using the algorithm and generating processed data.

34. The computer program of claim 33 further comprising a code segment for formatting the processed data.

35. The computer program of claim 33 further comprising a code segment for transmitting the processed data over a communications network.

36. The computer program of claim 33 wherein the data string is received through a communications network.

37. The computer program of claim 33 wherein the algorithm is retrieved from a database having two or more algorithms.
